(19) United States
(12) Patent Application Publication
(10) Pub. No.: US 2014/0348677 A1
(43) Pub. Date: Nov. 27, 2014

(54) Positive Displacement Pump and Suction Valve Module Therefor

(71) Applicants: Manuel Moeller, Tulsa, OK (US); Jason Neal Whaley, Bells, TX (US)

(72) Inventors: Manuel Moeller, Tulsa, OK (US); Jason Neal Whaley, Bells, TX (US)

(21) Appl. No.: 14/344,761

(22) PCT Filed: Sep. 14, 2012
(86) PCT No.: PCT/US2012/055591

§ 371 Date: Mar. 13, 2014

Related U.S. Application Data
(60) Provisional application No. 61/535,531, filed on Sep. 16, 2011.

(51) Int. Cl. F04B 39/10; F16K 15/06; F04B 15/02

(52) U.S. Cl. CPC F04B 39/1046; F04B 15/02; F16K 15/06
USPC 417/559

(57) ABSTRACT

A device for pumping a fluid comprises a suction valve module. In addition, the device comprises a discharge valve module. Further, the device comprises a fluid flow passage extending between the suction valve module and the discharge valve module. The suction valve module includes a valve housing block having a fluid inlet and a suction valve assembly disposed within the valve housing block. The suction valve assembly includes a moveable poppet element configured to reciprocate along a suction valve axis that is skewed relative to a central axis of the fluid inlet.

### CROSS-REFERENCE TO RELATED APPLICATIONS

This application is a 35 U.S.C. §371 national stage application of PCT/US2012/055591 filed Sep. 14, 2012 and entitled “Positive Displacement Pump and Suction Valve Module Therefor,” which claims priority to U.S. Provisional Application No. 61/535,531 filed Sep. 16, 2011 and entitled “Reciprocating Pump and Suction Valve Module Therefor,” both of which are hereby incorporated herein by reference in their entirety for all purposes.

### STATEMENT REGARDING FEDERALLY SPONSORED RESEARCH OR DEVELOPMENT

Not applicable.

### BACKGROUND

1. Field of Technology

The disclosure relates generally to positive displacement pumps, such as reciprocating pumps applied to drilling mud and well service applications, and to valves used therein to control the flow of the pumped fluid into and out of the pump. More particularly, the disclosure relates to a suction valve module for use in positive displacement pumps.

2. Background Information

Positive displacement pumps are used in various pumping applications. For example, reciprocating pumps are used in typical drilling operations to pressurize an abrasive slurry of solids and liquids known as drilling mud, which is then conveyed to the bottom of a borehole that is being drilled in the earth. The pressurized mud is used to maintain appropriate borehole pressure, lubricate and cool a downhole drill bit, and carry loosened sediment and rock cuttings from the borehole bottom to the surface. At the surface, the cuttings and sediment are removed from the returning drilling mud, and the now-filtered drilling mud may be recycled and pumped back to the borehole bottom. In various applications, diaphram pumps are used for viscous liquids and slurries, particularly abrasive, acidic, or caustic materials.

Suction and discharge valves are used in reciprocating pumps to control the flow of fluid into and out of the pump's cylinders where the fluid is pressurized. Due to the highly abrasive nature of the particles often present in the slurry being pressurized, the valves and seals of the pumps must be designed to resist harsh abrasion, while maintaining positive sealing action under relatively high operating pressures. Additionally, the valve elements and the structural components retaining them in the pump are exposed to very high and cyclic pressures. For example, a valve module containing a valve assembly may pressurize, reaching up to 7,500 psi or more, and then may relieve down to 0 psi many times per minute. This high cyclic pressure change creates stresses and can significantly impact the life of the components. It is common and expected that seals, gaskets, and other valve components will typically require replacement as a matter of routine as they wear. However, significant stresses in non-moving and more costly components, such as the module that houses the valve, can cause cracks to develop over time. This is, in part, due to the high cyclic pressures that create particular areas that experience high stress. Further, the direction of liquid flow may shorten component life if the abrasive slurry is directed particularly at one location in the module. In sum, the severe pressure variations, in conjunction with abrasive and often caustic fluid, can cause the valve housing or valve module to crack and fail in a relatively short time, necessitating that the pump be shut down and repaired. Repairs to the valve module are more time-consuming and expensive than replacing other valve components which are recognized as needing regular replacement.

Accordingly, it would be advantageous to design and provide a pump and valve modules for the pump that can better withstand high pressure, cyclic loading and provide for longer-lasting valve modules, thereby decreasing the need for making expensive and time-consuming replacements of those components.

### BRIEF SUMMARY OF THE DISCLOSURE

These and other needs in the art are addressed in one embodiment by a device for pumping a fluid. In an embodiment, the device comprises a suction valve module. In addition, the device comprises a discharge valve module. Further, the device comprises a fluid flow passage extending between the suction valve module and the discharge valve module. The suction valve module includes a valve housing block having a fluid inlet and a suction valve assembly disposed within the valve housing block. The suction valve assembly includes a moveable poppet element configured to reciprocate along a suction valve axis that is skewed relative to a central axis of the fluid inlet.

These and other needs in the art are addressed in another embodiment by a suction valve module for a pump. In an embodiment, the suction valve module comprises a housing including flow bore extending therethrough along a valve axis, a first end, and a second end opposite the first end. The flow bore includes a reduced diameter portion at the second end of the housing forming a fluid passageway for fluid to exit the housing. In addition, the suction valve module comprises a fluid inlet extending through the housing an inlet axis to the flow bore. The inlet axis is skewed relative to the valve axis. Further, the suction valve module comprises a valve cage coaxially disposed in the flow bore. The valve cage includes a first end, a second end, a cylindrical side wall disposed between the first end and the second end of the valve cage, an interior chamber disposed within the side wall between the first end and the second end of the valve cage, and a plurality of apertures extending radially through the side wall to the interior chamber. Still further, the suction valve module comprises a valve seat having an annular seating surface disposed in the flow bore. Moreover, the suction valve module comprises a poppet valve member configured to reciprocate axially relative to the valve axis within the flow bore. The suction valve module also comprises a biasing member configured to bias an annular sealing surface of the poppet valve member into engagement with the annular sealing surface of the valve seat.

These and other needs in the art are addressed in another embodiment by a reciprocating pump. In an embodiment, the reciprocating pump comprises a power end configured to reciprocate a piston within a cylinder. In addition, the reciprocating pump comprises a fluid end coupled to the power end and configured to draw fluid into the pump when the piston moves in a first direction and to discharge fluid from the pump when the piston moves in a second direction opposite the first direction. The fluid end further comprises a suction valve module, a discharge module, and a fluid flow passage extending between the suction valve module and the discharge valve module and providing fluid communication therebetween. The suction valve module comprises a fluid inlet for conveying fluid into the suction valve module in a first direction and a suction valve assembly disposed in the suction valve module. The suction valve assembly includes a movable poppet element configured to reciprocate within the suction valve module along a valve axis that is skewed relative to the first direction.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a more detailed description of the disclosed embodiments, reference will now be made to the accompanying drawings, wherein:

FIG. 1 is a partial, cross-sectional, schematic view of a reciprocating positive displacement pump in accordance with principles disclosed herein;

FIG. 2 is an enlarged cross-sectional view of the suction valve module of the pump of FIG. 1;

FIG. 3 is a cross-sectional, perspective view of the valve housing block of the suction valve module of FIG. 2;

FIG. 4 is a perspective view of the valve cage of the suction valve module of FIG. 2;

FIG. 5 is a cross-sectional, perspective view of the valve cage of FIG. 4;

FIG. 6 is a partial, cross-sectional, perspective view of select components, including the valve assembly, of the valve module of FIG. 2;

FIG. 7 is a cross-sectional exploded perspective view of the suction valve module of FIG. 2;

FIG. 8 is a cross-sectional view showing a conventional arrangement for the discharge and suction valve modules on a reciprocating pump;

FIG. 9 is a cross-sectional view of an embodiment of a suction valve module in accordance with principles disclosed herein and suitable for use with pump shown in FIG. 1;

FIG. 10 is a cross-sectional exploded perspective view of the suction valve module of FIG. 9;

FIG. 11 is a cross-sectional view of an embodiment of a suction valve module in accordance with principles disclosed herein and suitable for use with pump shown in FIG. 1;

FIG. 12 is a cross-sectional exploded perspective view of the suction valve module of FIG. 11;

FIG. 13 is a cross-sectional view of an embodiment of a suction valve module in accordance with principles disclosed herein and suitable for use with pump shown in FIG. 1;

FIG. 14 is a cross-sectional exploded perspective view of the suction valve module of FIG. 13;

FIG. 15 is a partial cross-sectional view of a fluid end of a reciprocating positive displacement pump in accordance with principles disclosed herein;

FIG. 16 is a cross-sectional view of the suction valve module of the fluid end shown in FIG. 15;

FIG. 17 is a cross-sectional exploded perspective view of the suction valve module of FIG. 16;

FIG. 18 is a cross-sectional view of an embodiment of a suction valve module in accordance with principles disclosed herein and suitable for use with the fluid end shown in FIG. 16; and

FIG. 19 is a cross-sectional exploded perspective view of the suction valve module shown in FIG. 18.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

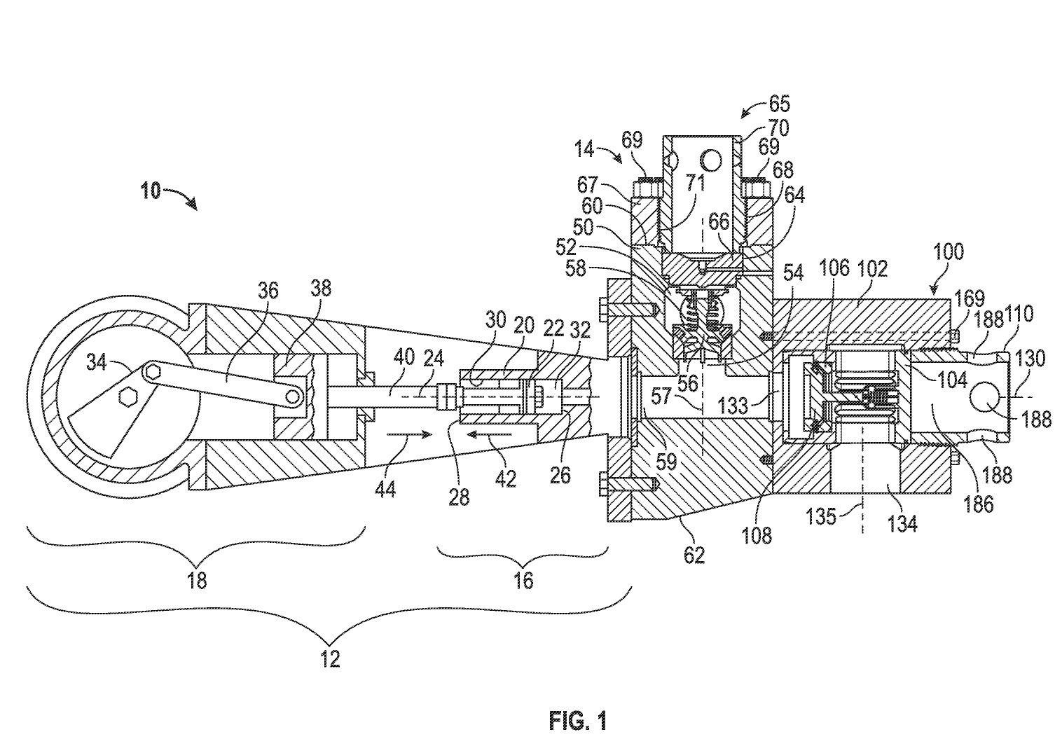

Referring now to FIG. 1, an embodiment of a positive displacement pump 10 for pumping a fluid (e.g., drilling mud) is shown. In this embodiment positive displacement pump 10 is a reciprocating pump 10 including a power end assembly 12, fluid discharge or outlet valve module 14 coupled to the power end assembly 12, and a fluid suction or inlet valve module 100 coupled to discharge module 14 and coupled to power end assembly 12. In this embodiment, the discharge module 14 is positioned between the power end assembly 12 and the suction module 100. Power end assembly 12 includes a piston-cylinder fluid section 16 proximal discharge module 14 and a power section 18 distal outlet module 14. Fluid section 16 includes a cylinder 20 and a piston 22. Cylinder 20 has a central axis 24 and includes a first end 26, a second end 28, and a through-bore 30 extending between ends 26, 28. Piston 22 is coaxially disposed within bore 30 and slidingly engages the inner surface of cylinder 20. Piston 22 and cylinder 20 define a chamber 32 within bore 30 between piston 22 and the cylinder's first end 26. Power section 18 includes a crankshaft 34, connecting rod 36, and crosshead 38. An extension rod 40 couples crosshead 38 to piston 22. During operation, a motor (not shown) powers the rotation of crankshaft 34. The rotational motion of crankshaft 34 is translated into the reciprocating axial displacement of piston 22 relative to cylinder 20. As piston 22 moves axially within bore 30 in a first direction represented by arrow 42, the volume within chamber 32 increases; however, as piston 22 moves axially within bore 30 in a second direction represented by arrow 44 (opposite first direction 42), the volume within chamber 32 decreases.

Referring still to FIG. 1, discharge valve module 14 comprises a body 50, a fluid outlet chamber 52 within body 50, a flow passage or conduit 54, a discharge valve 56 disposed between chamber 52 and conduit 54, and valve cover assembly 65 coupled to body 50. Discharge valve 56 extends along discharge valve axis 57 shared with conduit 54 of module 14. In this embodiment, discharge valve axis 57 is skewed relative to a suction valve axis 130 described in more detail below. In other words, discharge valve axis 57 is not aligned with or parallel to suction valve axis 130. In particular, discharge valve axis 57 is oriented perpendicular to suction valve axis 130. A fluid discharge conduit or outlet 58 is in fluid communication with chamber 52. Further, in this embodiment, fluid outlet 58 extends in a direction perpendicular to flow conduit 54. As will be described in more detail below, discharge valve 56 is configured to reciprocate along discharge valve axis 57 and regulate the flow of fluid between conduit 54 and chamber 52.

Body 50 has an upper end 60, a lower end 62, and a valve access bore 64 extending from upper end 60 to outlet chamber 52. Valve cover assembly 65 includes a plug 66 is disposed in bore 64 adjacent discharge valve 56, a annular valve cover 67 positioned atop valve body 50, and a cylindrical retainer 70, which may also be called a retaining ring, disposed within cover 67. Plug 66 retains the position of discharge valve 56 and prevents fluid flow through the bore 64. Annular valve cover 67 includes a threaded through-bore 68 and is retained on valve body 50 by threaded fasteners 69. Cylindrical retainer 70 having a threaded segment 71 on its outer diameter threadingly engages threaded bore 68 of valve cover 67 and retains plug 66 in bore 64.

Discharge valve module 14 further includes a through-bore 59 that is in fluid communication with chamber 32 in the fluid end 16 of power end assembly 12. In FIG. 1, a through-bore extends between chamber 32 and bore 59 to allow fluid communication therebetween. Bore 59 is further in fluid communication with the flow passage 133 of suction valve module 100, as described more fully below. Similarly, bore 59 intersects and is in fluid communication with conduit 54.

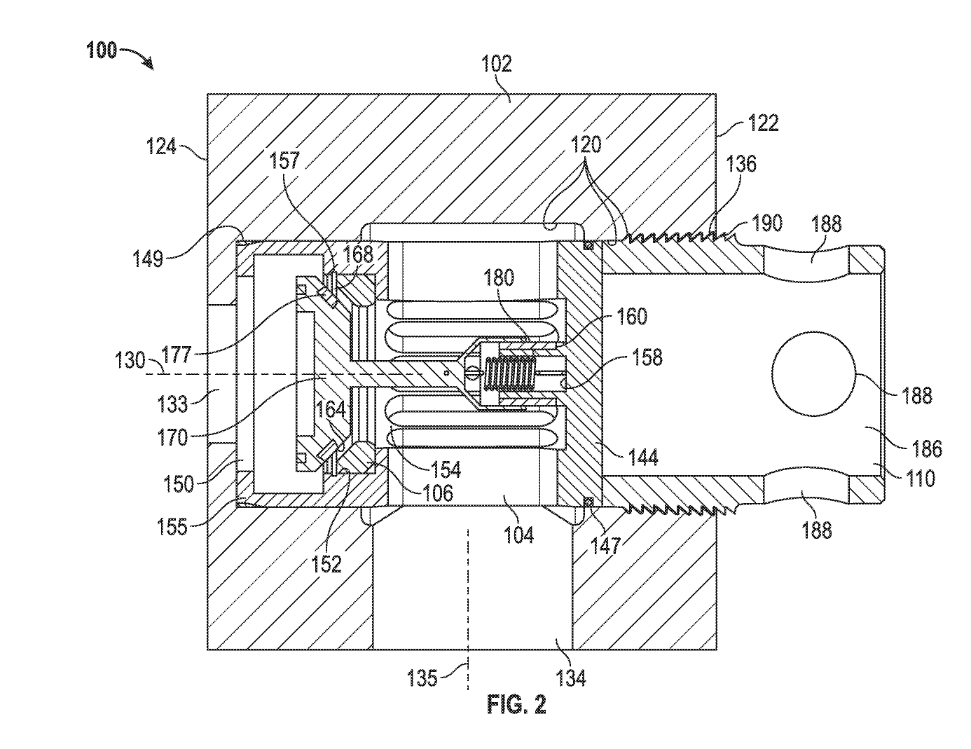

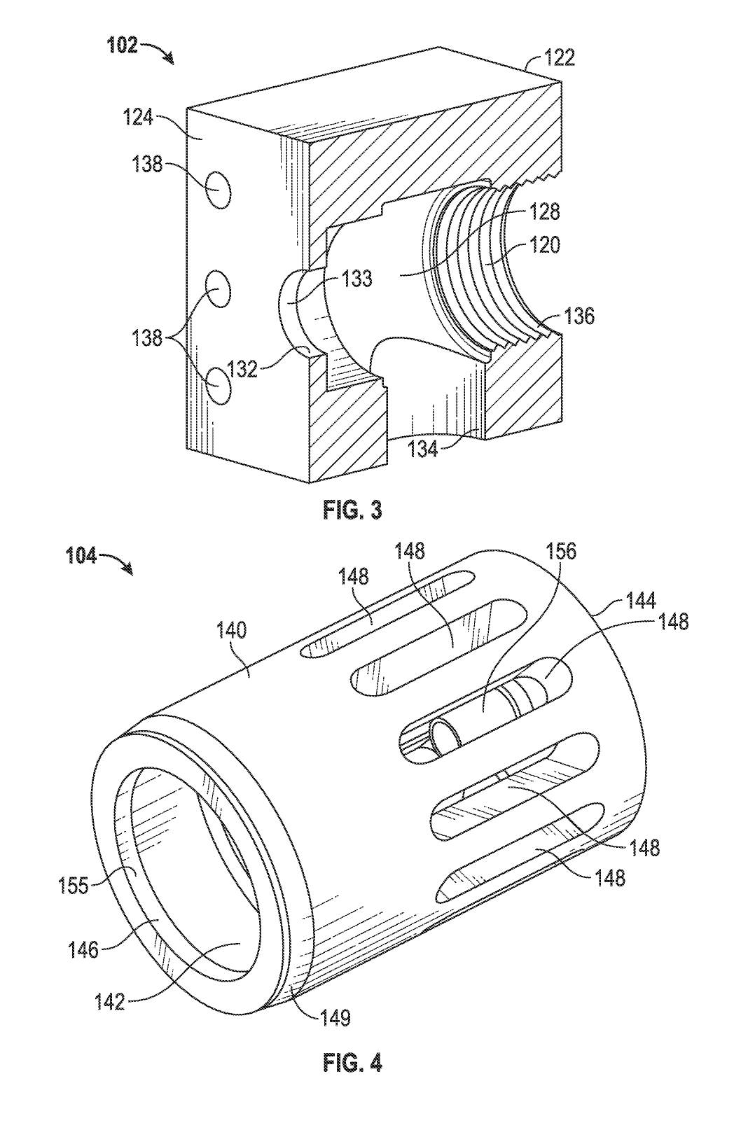

Referring now to FIGS. 1, 2 and 7, suction valve module 100 generally includes valve housing block 102, valve cage 104, valve assembly 108, a longitudinal suction valve axis 130, and cylindrical retainer 110. As best shown in FIGS. 2 and 3, valve housing block 102 includes a through-bore 120 which extends axially (i.e., along axis 130) between the block's outermost and innermost surfaces 122, 124, respectively. Through-bore 120 includes a generally central portion of increased diameter 128 and portion of reduced diameter 132, reduced diameter portion 132 being adjacent to innermost surface 124 and forming a flow passage 133. In this embodiment, flow passage 133, central portion 128, and the entire through-bore 120 are coaxially aligned with suction valve axis 130. Housing block 102 also includes a suction inlet 134 extending along an inlet axis 135 and intersecting the through-bore 120 in the central portion 128. As best shown in FIGS. 1 and 2, inlet 134 is positioned such that suction valve axis 130 is skewed (is non-parallel) relative to inlet axis 135. In particular, valve axis 130 is perpendicular to inlet axis 135. During operation, fluid is pumped into central portion 128 via suction inlet 134 and exits suction valve housing block 102 via flow passage 133, where it next enters bore 59 of discharge valve module 14.

As best shown in FIG. 2, the portion of through-bore 120 adjacent to outermost surface 122 includes an internally threaded segment 136 for receiving the threaded, cylindrical retainer 110, described below. Valve housing block 102 further includes through-bores 138 (FIG. 3) for receiving bolts or similar threaded fasteners 169 (FIG. 1) for attaching valve housing block 102 to the discharge valve module 14.

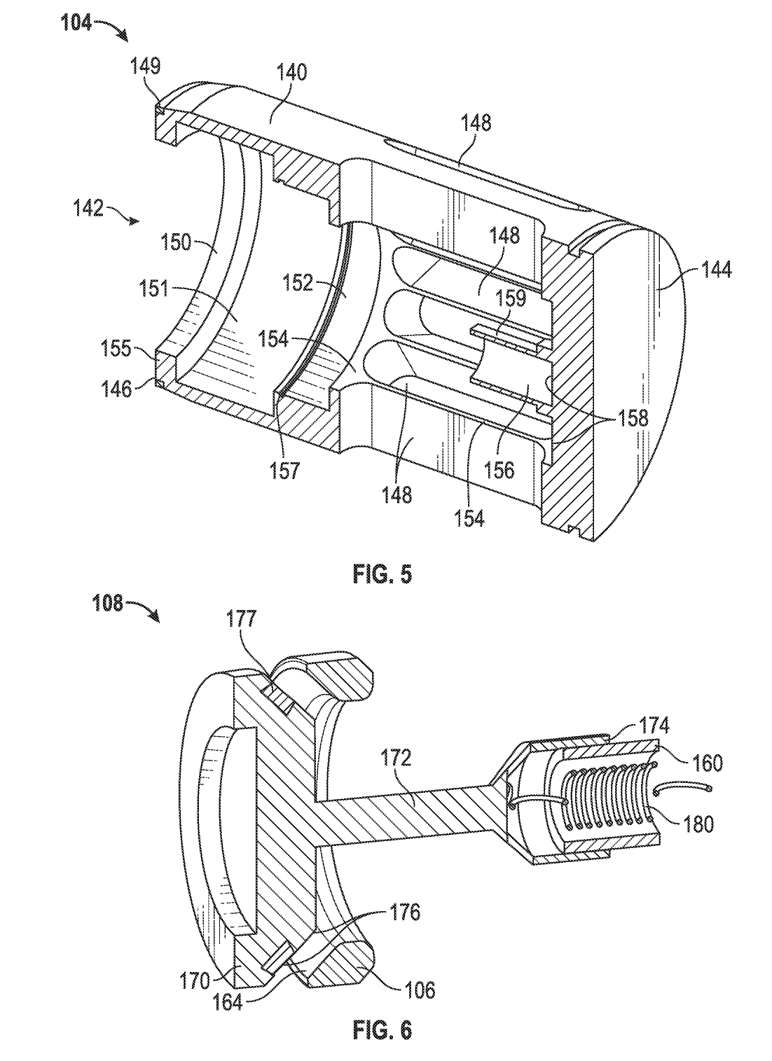

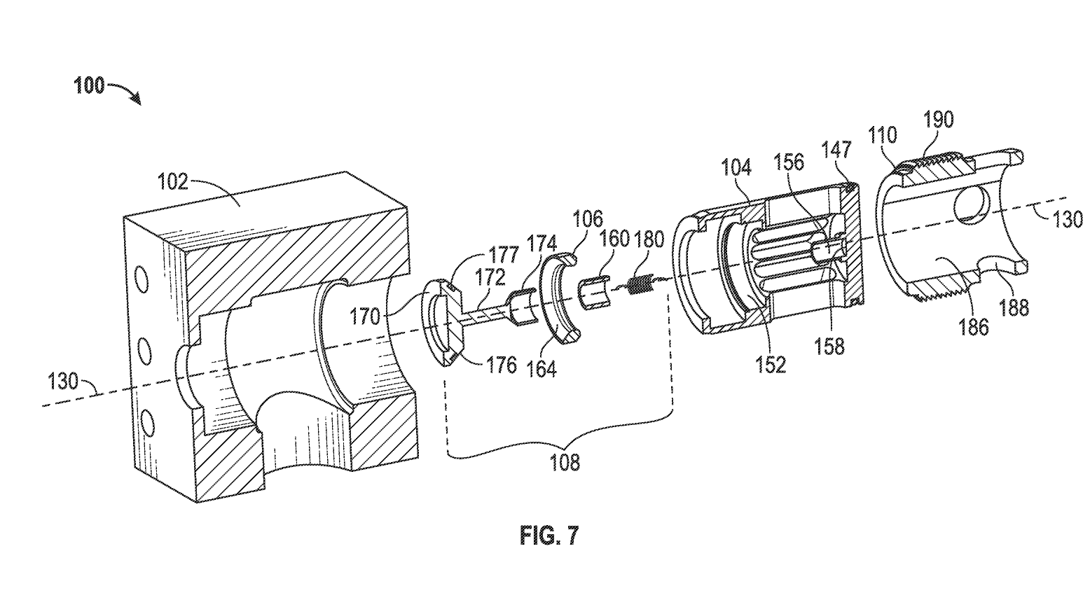

Referring now to FIGS. 2, 4, and 5, valve cage 104 is disposed within the through-bore 120 of suction valve module 100. In this embodiment, valve cage 104 includes a generally cylindrical sidewall 140 surrounding an interior chamber 142, a closed end 144, and an open end 146. Formed through sidewalls 140 and adjacent closed end 144 are a plurality of circumferentially-spaced apertures, which, in the embodiment shown in FIGS. 2, 4, and 5, are elongated slots 148. Each slot 148 extends in a longitudinal direction parallel to axis 130 and is in fluid communication with interior chamber 142, which extends axially from internal surface 158 of closed end 144 through open end 146. The interior chamber 142 varies in diameter and, in particular, has segments 150, 151, 152, 154 of differing diameters as best shown in FIG. 5. Segment 154, which is closest to closed end 144 and intersects slots 148, has the smallest diameter. Segment 150 forms an annular lip or flange 155 at open end 146. Interior chamber segment 152 includes an annular groove 157 for retaining a snap ring 168, described below and shown in FIG. 2. FIG. 5 illustrates that closed end 144 includes an annular extension 156 extending inwardly from internal surface 158 into chamber 142. Annular extension 156 extends coaxially with valve axis 130 into chamber section 154, the annular extension 156 including a segment 159 of reduced outer diameter for receiving friction-reducing, annular bushing 160 (FIGS. 2 and 7).

Referring now to FIGS. 6 and 7, suction valve assembly 108 includes a valve seat 106 and poppet element or poppet valve member 170. Valve seat 106 includes a generally frustoconical or beveled seating surface 164 for mating and engaging the movable poppet valve member 170. Snap ring 168 retains valve seat 106 within segment 152 of the valve cage 104. Poppet valve member 170 is coaxially aligned with suction valve axis 130 and includes a valve stem 172 having a hollow receiving end 174. Poppet valve member 170 further includes an annular, frustoconical surface 176 around a disc-shaped head for sealingly engaging with the beveled seating surface 164 of valve seat 106. Frustoconical surface 176 may also be described as a beveled surface. An annular seal gasket 177 is incorporated into the sealing surface 176. In various other embodiments, sealing surface 176 does not include a seal gasket 177. Hollow receiving end 174 has a cylindrical bore that is sized to slidingly receive an annular bushing 160. As best shown in FIG. 2, biasing member or return spring 180 is connected between cage inner surface 158 and hollow end 174 of stem 172 in order to provide a biasing force to return poppet member 170 into sealing engagement with valve seat 106 when the pressure within the suction valve module 100 drops to a predetermined value.

Referring to FIGS. 1, 2, and 7, valve cage 104 and valve assembly 108 are retained within housing block 102 via cylindrical retainer 110. Retainer 110 includes a central through-bore 186 longitudinally aligned with valve axis 130. Retainer 110 further includes transverse holes 188 used for receiving a rod or other tool (not shown) employed to rotate the cylindrical retainer 110. Retainer 110 includes an externally-threaded segment 190 for threadingly engaging threaded segment 136 of through-bore 120 within valve housing block 102.

Referring now to FIGS. 2 and 7, the assembly of suction valve module 100 is accomplished by attaching annular seal gasket 177 to poppet member 170 in valve assembly 108. Valve seat 106 is attached to segment 152 of valve cage 104 via snap ring 157. Friction-reducing bushing 160 is disposed over annular extension 156 of valve cage 104. Return spring 180 is connected internally within hollow receiving end 174 of valve assembly 108 and to bottom surface 158 within annular extension 156 of valve cage 104. An annular seal 149 (best shown in FIGS. 2 and 5) is disposed about valve cage 104 adjacent open end 146. Another annual seal 147 (FIG. 2) is disposed within a groove about sidewall 140 of valve cage 104 adjacent closed end 144. With valve assembly 108 disposed within valve cage 104, the cage 104 is disposed within bore 120 of housing block 102. Threaded, cylindrical retainer 110 is then threaded into valve housing block 102 to secure the components within housing block 102.

Referring now to FIG. 1, through-bore 120 and chamber 142 of suction valve module 100 are in fluid communication with suction inlet 134 and with bore 59 of discharge valve module 14 which, in turn, is in fluid communication with chamber 32 of fluid section 16. Thus, suction valve 108, and discharge valve 56 may be described as being hydraulically coupled to fluid section 16 of power end assembly 12 via conduits 54, 59 of discharge module 14 and via through-bore 120 and chamber 142 in suction valve module 100. Each valve 56, 108 is configured to allow flow therethrough in only one direction. In particular, valves 56, 108 are configured and arranged such that suction valve 108 allows fluid to flow from fluid inlet 134 into passage 133 of through-bore 120 and into conduits 54, 59, and discharge valve 56 allows fluid to flow from conduits 54, 59 into outlet chamber 52 and fluid outlet 58. Suction valve 108 prevents fluid flow from conduits 54, 59 into fluid inlet 134, and discharge valve 56 prevents fluid flow from fluid outlet 58 and chamber 52 into conduits 54, 59.

During operation of pump 10, a motor (not shown) drives the rotation of crankshaft 34, which results in the reciprocating axial translation of piston 22 relative to cylinder 20. As piston 22 reciprocates within bore 30, the volume of chamber 32 cyclically expands and contracts. Since chamber 32 is in fluid communication with conduits 54, 59 of discharge valve module 14 and with through-bore 120 in suction valve module 100, the expansion and contraction of the volume within chamber 32 results in a decrease and increase, respectively, in the fluid pressure within conduits 54, 59 and through-bore 120. Thus, when piston 22 moves in second direction 44, the volume in chamber 32 decreases, and fluid pressure in conduits 54, 59 increases. In response to the increased fluid pressure, suction valve 108 closes, and discharge valve 56 opens. When discharge valve 56 opens, the pressurized fluid in conduits 54, 59 flows into chamber 52 and then out through fluid outlet 58. When piston 22 reverses direction and moves in first direction 42, the volume in chamber 32 increases and fluid pressure in conduits 54, 59 decreases. In response to the reduced fluid pressure, discharge valve 56 closes, and suction valve 108 opens. When suction valve 108 opens, fluid flows from fluid inlet 134 into increased diameter portion 128 of through-bore 120 that encircles valve cage 104. The fluid then passes in a radial direction (relative to valve axis 130) thought slots 148 and into the interior chamber 142 of cage 104. While inside cage 104, the fluid passes through the center of valve seat 106 and past the outer circumference of poppet valve member 170. From there, it enters reduced diameter portion 132 of through-bore 120, which forms flow passage 133. From passage 133, the fluid exits valve block 102, passing into conduits 54, 59. The cycle then repeats.

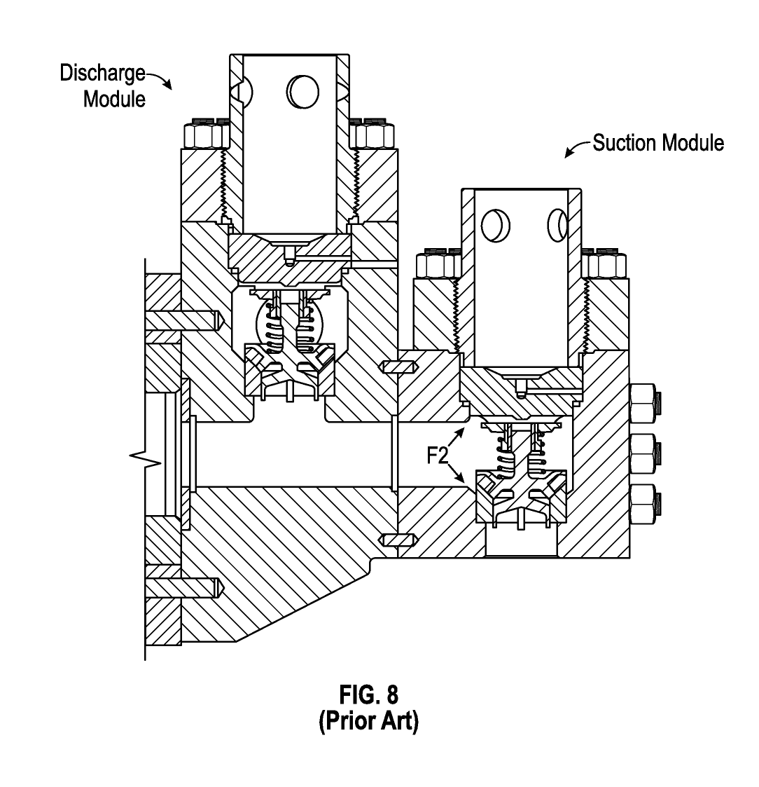

As understood from the description above and still referring to FIG. 1, suction valve 108 is retained in suction valve module 100 such that suction valve axis 130 is oriented perpendicular to both the suction inlet axis 135 and the discharge valve axis 57 of the discharge valve 56. Unlike a conventional valve arrangement as shown in FIG. 8, fluid entering the suction valve module 100 (FIGS. 1 and 2) undergoes a change in direction, i.e., essentially makes a 90° turn, before it impinges on valve seat 106 or the sealing surface 176 of poppet 170. More specifically, the fluid entering valve module 100 encircles the valve cage 104 and passes radially through slots 148 before turning into the passage between chamber segments 154, 150 that is opened and closed by suction valve assembly 108. This transforms the direction of fluid flow from being perpendicular to the valve axis 130 as it enter suction module 100 to being parallel to valve axis 130 at the location where the poppet 170 unseats and allows flow to enter the discharge module 14. As a consequence, the potential for developing a location of extraordinarily high-stress in the suction module 100 is substantially reduced or eliminated. This benefit results because the fluid passing between the valve seat 106 and the open poppet 170 into flow passage 133 has already changed direction and is already flowing in through-bore 120 in a direction substantially parallel to valve axis 130. This arrangement is intended to lower the stresses in module 100 significantly below the stresses associated with certain conventional, prior art valves. High stresses could lead to excessive wear and cracking of a suction module. High stress areas exist in the bore intersections in conventional valve modules. The configuration of bores and flow passages in suction valve module 100 allows the bore intersections, which might otherwise experience cyclical pressure exposures between 0 and 7500 psi or much higher, now are only exposed to relatively low static pressures, such as a maximum of 150 psi, for example. In module 100, the intersection between suction inlet 134 and through-bore 120 is one such bore intersection. This arrangement of valve module 100 is intended to increase the life of the valve housing block 102.

It should also be appreciated that the embodiment of suction valve 100 shown in FIG. 8, the direction of motion of poppet member 170 and valve stem 172 of suction valve assembly 108 is parallel to the direction of the stroke of piston 22. In the conventional valve arrangement shown in FIG. 8, the suction and discharge valves are oriented in the same direction, meaning that their respective axes are parallel to one another and both are perpendicular to the direction of the stroke of piston 22 and also perpendicular to the flow bore extending between the suction module and the discharge module. In this arrangement, the suction valve is oriented parallel to the suction inlet, and its valve axis is substantially co-axial with the suction inlet. Here, when the suction valve poppet displaces such that the valve is opened, fluid entering the suction valve chamber impinges directly on the open valve poppet and then impinges on circular location F2 within the suction module. The fluid then makes a substantially 90° turn in order to flow into the flow bore toward the discharge valve module. This flow pattern creates high wear and high stress locations, particularly at F2. Over time, the suction module may crack in the vicinity of F2, requiring the pump to be shut down in order to replace the suction module, a time consuming and costly procedure.

By contrast, in the design and arrangement shown in FIGS. 1 and 2, valve housing block 102 experiences less stress or wear than does the housing block of suction valve in FIG. 8. This improvement in block 102 is due in part because fluid passing from the suction inlet 134 through the poppet 170 first changes direction within the valve cage 104 before reaching poppet 170 or at least before reaching the flow-controlling portion of poppet 170, namely sealing surface 176. Any substantial wear arising from the fluid flow pattern takes place in the more expendable valve cage 104 or valve assembly 108, rather than affecting the valve body 102. Valve cage 104 and the components of valve assembly 108 are more easily replaced, and less expensive to replace, than the valve housing block 102.

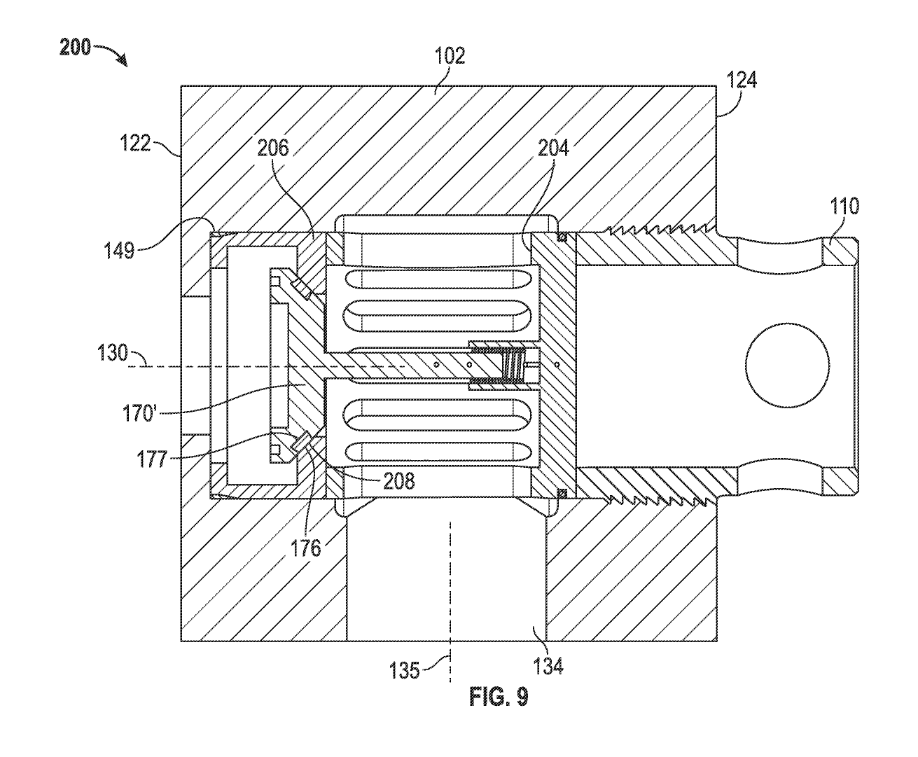

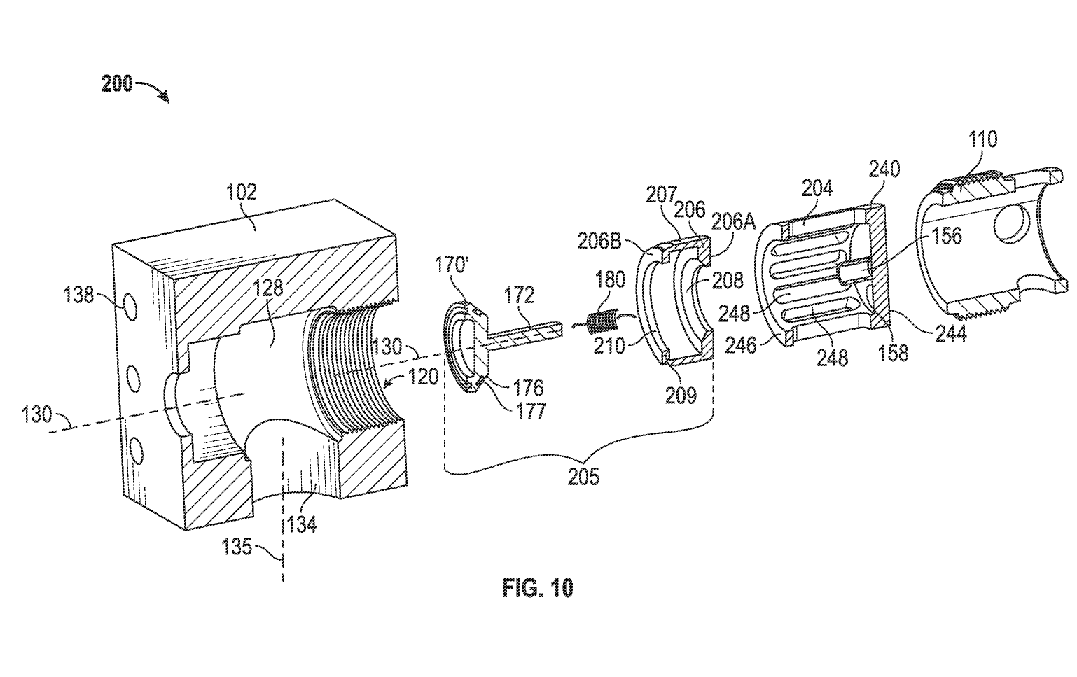

Referring now to FIGS. 9 and 10, another embodiment of a suction valve module 200 that can be used in place of suction valve module 100 in pump 10 previously described is shown. In this embodiment, suction valve module 200 includes valve block 102 having a through-bore 120, and a valve axis 130, each as previously described. Module 200 further includes a valve cage 204 and a valve assembly 205, each disposed within bore 120, for selectively conducting or inhibiting fluid flow therethrough. Valve cage 204 includes generally cylindrical sidewall 240 surrounding an interior chamber 242, a closed end 244, and an open end 246. Formed through sidewall 240 are a plurality of circumferentially-spaced apertures which, in this embodiment, are elongate slots 248. Each slot 248 is oriented parallel to axis 130 and extends radially completely through sidewall 240. The interior chamber 242 extends axially from closed end 244 through open end 246. Similar to cage 104 previously described, the closed end 244 of cage 204 includes an annular extension 156 extending axially from internal surface 158 into chamber 142.

In the embodiment shown in FIGS. 9 and 10, valve assembly 205 includes a movable poppet element or poppet valve member 170′ and an annular valve seat 206 through which poppet element 170′ extends. Poppet valve member 170′ is substantially the same as member 170 previously described. Namely, member 170′ includes a stem 172 extending along axis 130 and an annular, frustoconical surface 176 with an annular seal gasket 177 incorporated therein. However, in this embodiment, member 170′ does not include a hollow receiving end 174.

Valve seat 206 is a generally cylindrical member having a cylindrical outer surface 207, an annular, generally frustoconical or beveled valve seating surface 208 extending radially inward at a first end 206A, and an annular lip or flange 209 extending radially inward at a second end 206B. Annular lip 209 has an inner cylindrical surface 210 that defines a through-hole at a second end 206B. In FIGS. 9 and 10, the diameter of surface 210 is greater than reduced diameter portion 132 of housing block 102. As assembled, first end 206A of valve seat 206 is positioned axially adjacent open end 246 of cage 204. Valve stem 172 is seated end and slidingly engages annular extension 156, and thus, extension 156 functions to guide the axial reciprocation of valve stem 172. Spring 180 is attached at one end to stem 172 and the other end is attached to closed end 144 within extension 156. Spring 180 biases poppet valve member 170′ to sealingly engage frustoconical surface 176 with the mating seating surface 208 of valve seat 206 unless flow conditions displace surface 176 from seating surface 208. In this embodiment, valve cage 204 is axially shorter than cage 104 previously described, however, the valve seat 206 is axially longer than seat 106 previously described embodiment. The flow pattern through suction valve module 200 of FIG. 9 is generally the same as that described for module 100, the arrangement of module 200 also avoiding the high stress and high wear location described with reference to FIG. 8.

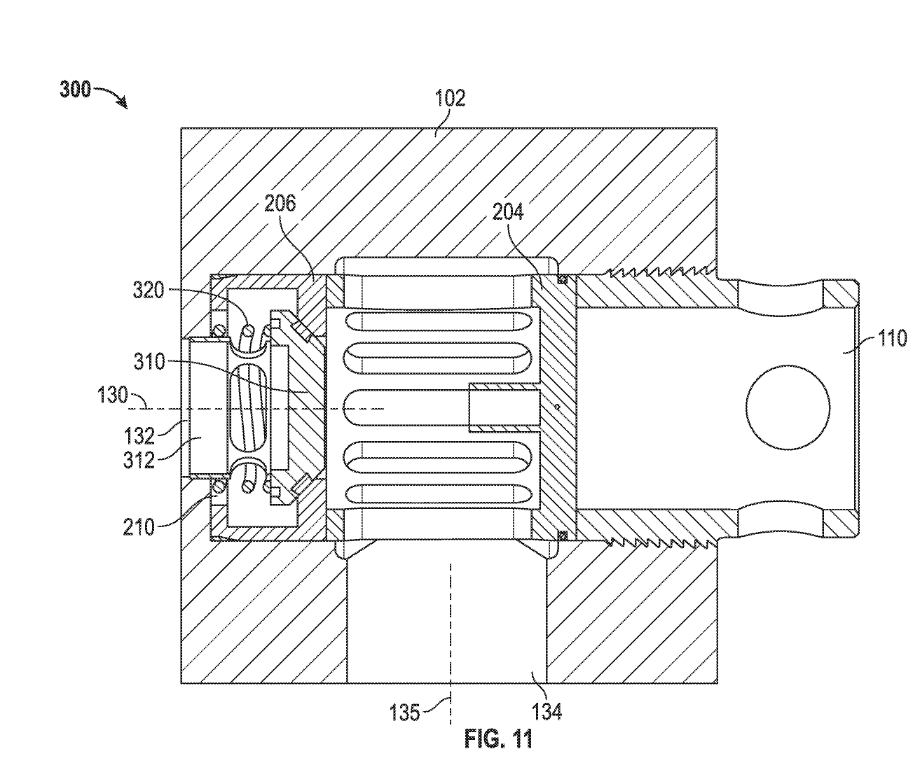

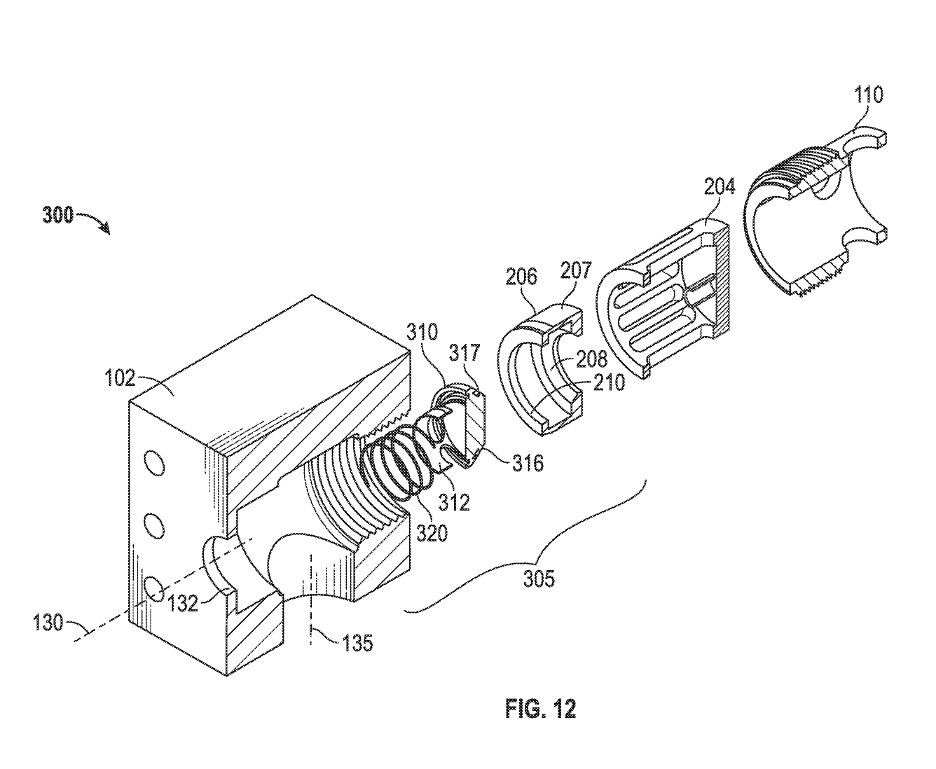

Referring now to FIGS. 11 and 12, another embodiment of a suction valve module 300 that can be used in place of suction valve module 100 in pump 10 previously described is shown. In this embodiment, suction valve module 300 includes valve block 102 having a through-bore 120 and valve axis 130, each as previously described. In addition, module 300 includes a valve cage 204 as previously described disposed within bore 120 and a valve assembly 305 dispose within bore 120 for selectively conducting or inhibiting fluid flow therethrough. In this embodiment, valve assembly 305 includes valve seat 206 as previously described and a movable poppet element or poppet valve member 310 that selectively engages seating surface 208. In particular, valve member 310 has a guide portion 312 that is coaxially aligned with axis 130 and an annular, frustoconical sealing surface 316 for sealingly engaging with beveled seating surface 208. The frustoconical sealing surface 316 may also be described as a beveled surface and incorporates an annular seal gasket 317. Valve guide portion 312 slidingly engages reduced diameter portion 132 of through-bore 120, which guides the axial reciprocation of valve member 310. In this embodiment, a biasing member or return spring 320 is disposed about glide portion 312 between housing block 102 and an annular shoulder on valve member 310. Return spring 310 biases poppet valve member 310 to a closed position engaging valve seat 206. The flow pattern through the suction valve module 300 of FIG. 11 is generally the same as that described for the previous embodiments, this arrangement also avoiding the high stress and high wear location described with reference to FIG. 8.

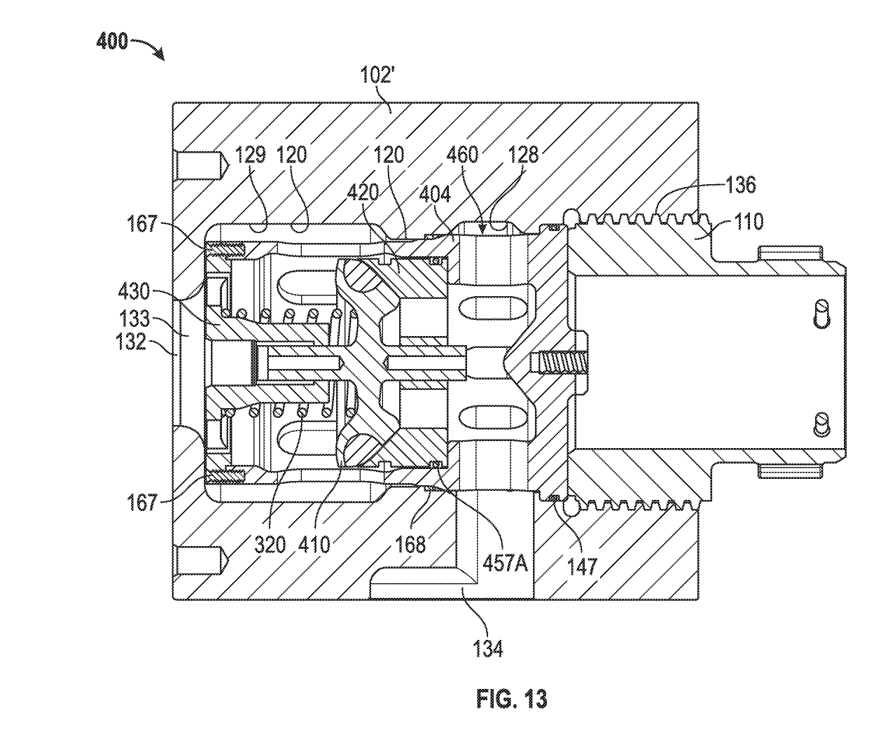

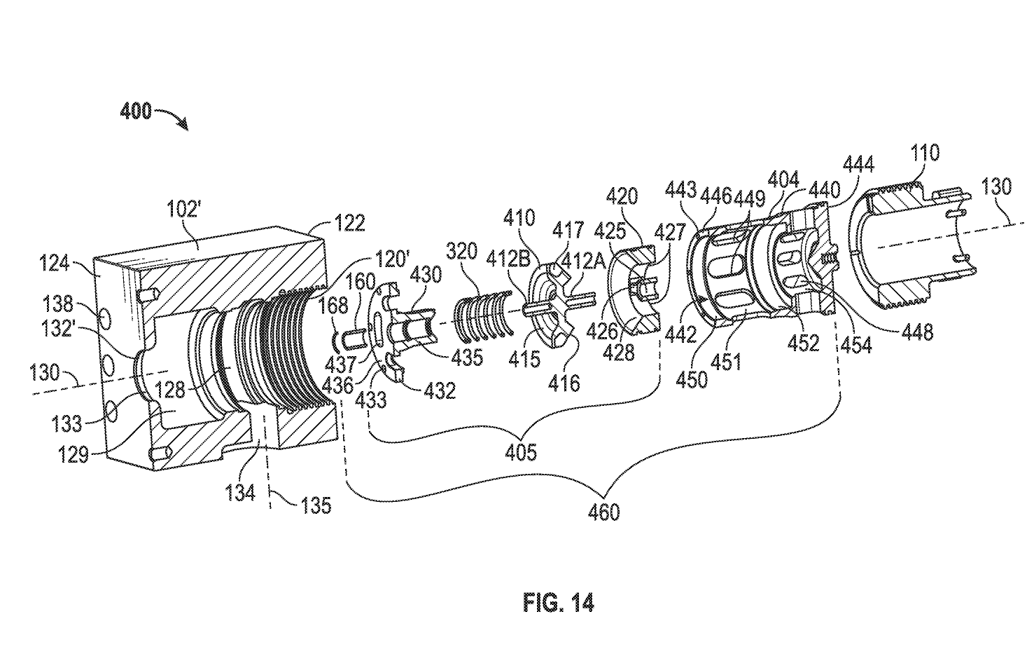

Referring now to FIGS. 13 and 14, another embodiment of a suction valve module 400 that can be used in place of suction valve module 100 in pump 10 previously described is shown. In this embodiment, suction valve module 400 includes a valve housing block 102′, a valve cage 404, a valve assembly 405 disposed within cage 404, and a cylindrical retainer 110 as previously described. When coupled together, valve cage 404 and valve assembly 405 form a combined assembly 460, as will be discussed in more detail below.

Valve block 102′ is substantially the same as block 102 previously described. Namely valve block 102′ includes a through-bore 120′ extending between surfaces 122, 124 and coaxially aligned with valve axis 130. Valve cage 404, valve assembly 405, and retainer 110 are coaxially aligned with a valve axis 130. Through-bore 120′ includes central portion of increased diameter 128, a reduced diameter portion 132′ extending axially from inner surface 124 and defining flow passage 133, and an internally threaded segment 136 extending axially from outermost surface 122 for receiving the threaded cylindrical retainer 110. However, unlike through-bore 120 and reduced diameter portion 132 previously described, in this embodiment, reduced diameter portion 132′ is smoothly contoured and rounded. Valve block 102′ also includes suction inlet 134 that intersects through-bore 120′ in the central portion 128 and has an inlet axis 135.

As best shown in FIG. 13, suction valve axis 130 is skewed relative to inlet axis 135 (i.e., axes 130, 135 are non-parallel). In particular, axes 130, 135 are oriented perpendicular to each other. Thus, suction inlet 134 extends generally perpendicular to valve axis 130. In addition, through-bore 120′ includes a second portion of increased diameter 129 proximal to passage 133 and to innermost surface 124.

Valve cage 404 and valve assembly 405 are disposed within through-bore 120′ for selectively conducting or inhibiting fluid flow therethrough. In this embodiment, valve cage 404 includes cylindrical sidewall 440 surrounding an interior chamber 442, a closed end 444, an open end 446, a first plurality of circumferentially-spaced apertures or slots 448, and a second plurality of circumferentially-spaced apertures or slots 449 axially spaced from slots 448. A plurality of, circumferentially-spaced internally threaded counter bores 443 extend axially from open end 446 into the side wall 440 of valve cage 404.

Slots 448, 449 extend radially through sidewall 440 to interior chamber 442. Chamber 442 extends axially from closed end 444 through open end 446 and varies in diameter. In particular, chamber 442 includes a plurality of axial adjacent segments 450, 451, 452, 454 (moving axially from open end 446 to closed end 444) of differing diameters as best shown in FIG. 14. Segment 454 axially adjacent closed end 444 has the smallest diameter. The first plurality of slots 448 extend radially to chamber segment 454 and function as fluid inlets for cage 404. The second plurality of slots 449 extend radially to chamber segment 451 proximal open end 446 and function as fluid outlets for cage 404. In particular, slots 449 allow fluid communication between chamber 442 and enlarged portion 129 of through-bore 120′. In this embodiment, slots 448, 449 are elongate slots oriented parallel to axis 130.

Referring still to FIGS. 13 and 14, valve assembly 405 includes a movable poppet element or poppet valve member 410 having two opposing stems 412A, 412B coaxially aligned with axis 130, an annular valve seat 420 through which first stem 412A extends, a valve guide 430 through which second stem 412B extends, and a biasing member or spring 320 disposed between poppet valve member 410 and valve guide 430. Valve seat 420 includes annular, beveled seating surface 428 and a centrally-located guide sleeve 425 held by multiple radial supports 426 extending from the base of seating surface 428. The fluid flow path through valve seat 420 is divided between a plurality of passages 427 formed between radial supports 426. Poppet valve member 410 includes a disc-shaped body 415 including an annular, frustoconical surface 416 provided with a seal gasket 417. Surface 416 is designed to mate and sealingly engage the beveled seating surface 428 of valve seat 420. Body 415 is axially positioned between stems 412A, 412B such that the center of gravity of poppet valve member 410 is located at the intersection of body 415 and stems 412A, 412B. The inner surface of guide sleeve 425 slidingly engages poppet stem 412A. A friction-reducing bushing can be disposed between stem 412A and guide sleeve 425.

Valve guide 430 includes an annular base 432 and a concentric guide sleeve 435 extending axially from base 432. Guide sleeve 435 is coaxially aligned with valve axis 130 and slidingly receives second stem 412B of poppet valve member 410. A friction-reducing bushing 160 is disposed between stem 412B and guide sleeve 435, and is retained in place with a snap ring 168 seated in an annular groove within the guide sleeve 435. Base 432 includes a plurality of circumferentially-spaced flow passages 437 disposed about guide sleeve 435 and extending axially therethrough. Flow passages 437 define radial supports 436 that connect base 432 to sleeve 435. Base 432 also includes a plurality of axial through-bores 433 circumferentially-spaced about is periphery for alignment with threaded counter bores 443 of cage 404. As shown in FIG. 13, threaded fasteners 167 are disposed in through-bores 433 and threadingly engage counter bores 443 to hold valve guide 430 to cage 404 with poppet valve member 410, valve seat 420, and spring 320 within cage 404. In this manner, valve assembly 405 is coupled to cage 404, forming the combined assembly 460, which may be inserted or removed from block 102′ as a single unit. In combined assembly 460, spring 320 is compressed and consequently biases poppet valve member 410 axially away from annular base 432 of valve guide 430 and into sealing contact with valve seat 420. An annular sealing member 457A is disposed in a circumferential groove in sidewall 440 and sealingly engages block 102′.

Valve cage 404 and valve assembly 408 are retained within housing block 102′ by the cylindrical retainer 110, having one end threadingly engaged with segment 136 of through-bore 120′. In the embodiment shown in FIGS. 13 and 14, the outer end of retainer 110 includes radially-extending protrusions for engaging a removal tool (not shown) employed to rotate the retainer 110.

With suction valve module 400 assembled, slots 448 of cage 404 are aligned with increased diameter portion 128 of through-bore 120′ and suction inlet 134, and slots 449 are align with increased diameter portion 129 of through-bore 120′. The flow pattern from inlet 134 through bore 120′ to passage 133 is generally the same as for various other embodiments described previously. In particular, fluid entering the valve module 400 undergoes a change in direction, i.e., essentially makes a right-angle turn, before it impinges on valve seat 420 or the sealing surface 416 of poppet 410. Thus, module 400 also avoids developing the high stress and high wear location described with reference to FIG. 8. After changing direction beyond inlet 134, fluid flow through valve seat 420 and poppet 410 may proceed as follows. When pressure within pump 10 causes spring 320 to compress, allowing fluid flow to pass poppet valve member 410, the travel distance of poppet member 410 is limited by guide sleeve 435. Thus, poppet member 410 is inhibited from contacting the base 432 and blocking fluid from exiting suction module 400. During operation, fluid passes through valve seat 420 and passes around annular sealing surface 416 traveling radially into or through slots 449 and continuing an axial path of travel, possibly entering increased diameter portion 129 of through-bore 120′. After traveling axially beyond sealing surface 416, the fluid reenters chamber 442 of cage 404 and exits through flow passage 133 of suction valve module 400.

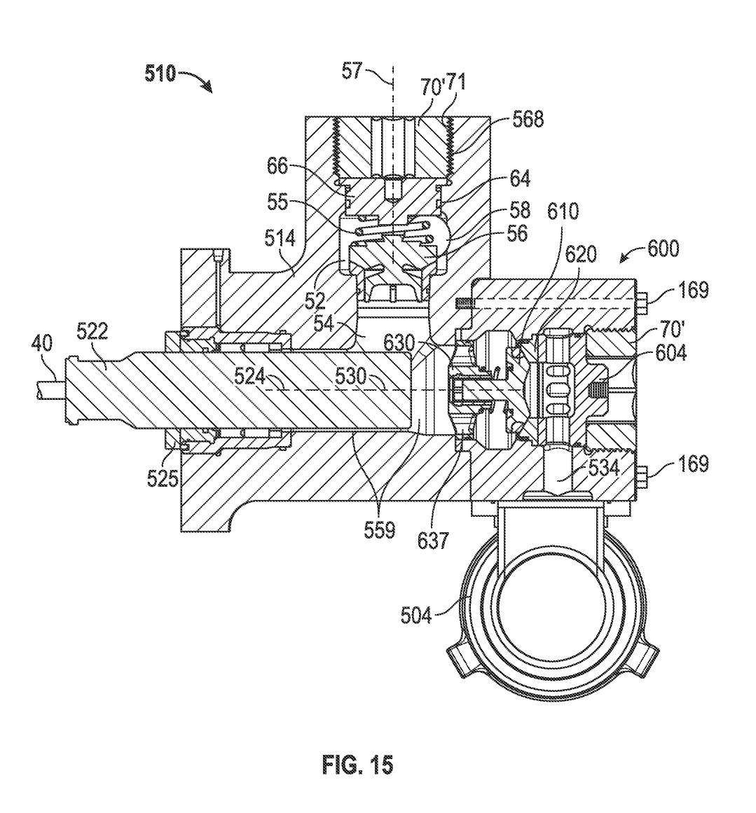

Referring now to FIG. 15, an embodiment of a fluid end 510 of a positive displacement pump, and in particular, a reciprocating pump for pumping a fluid is shown. In this embodiment, fluid end 510 is configured for use on a well service pump in which a discharge block 514 functions as a cylinder for a plunger 522. A suction valve module 600 is coupled to block 514 generally opposite plunger 522. Discharge block 514 includes a through bore 559 within which plunger 522 axially reciprocates. An annular packing assembly 525 is radially disposed between block 514 and plunger 522. Packing assembly 525 forms an annular static seal with block 514 and an annular dynamic seal with plunger 522, which slidingly engages packing 525. Plunger 522 is driven by a power section 18 as previously disclosed. In particular, extension rod 40 is coupled to plunger 522 and drive the axial reciprocation of plunger 522 within block 514.

Discharge block 514 is similar to block 14 previously described. In particular, discharge block 514 includes a flow passage or conduit 54, a fluid outlet chamber 52, a discharge valve access bore 64, and a threaded counter-bore 568, which are disposed end-to-end and coaxially aligned along a discharge valve axis 57, extending perpendicular to central axis 524 of through-bore 559. A fluid discharge conduit or outlet 58 is in fluid communication with chamber 52. In this embodiment, fluid outlet 58 extends in a direction perpendicular to flow conduit 54. A discharge valve 56 is disposed between chamber 52 and conduit 54, and a generally cylindrical plug 66 is disposed in bore 64 adjacent discharge valve 56, holding a biasing member or spring 55 against valve 56. Plug 66 is held by an externally threaded retaining ring 70′ threadingly received by counter-bore 568. Discharge valve 56, spring 55, plug 66, and retainer 70 are coaxially aligned with axis 57. Discharge valve 56 is configured to reciprocate along discharge valve axis 57 and regulate the flow of fluid between conduit 54 and chamber 52. Bore 559 intersects and is in fluid communication with conduit 54 and fluid flow passages 637 of suction valve 600, which will be described subsequently. The retaining ring 70′ includes a hexagonal central bore for engaging a removal tool, such as an Allen wrench.

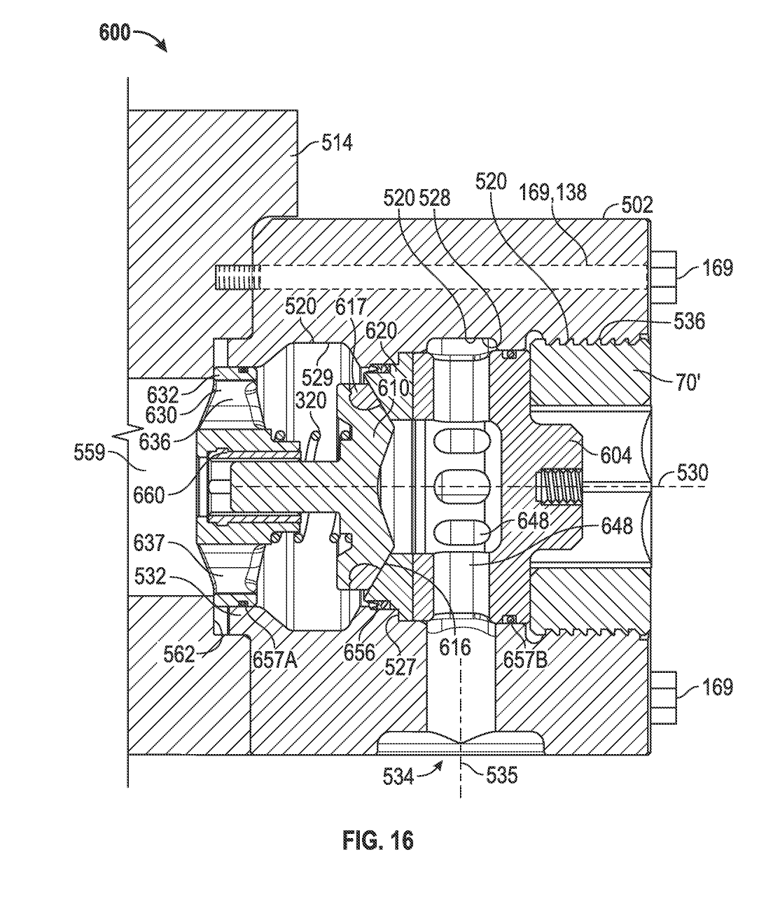

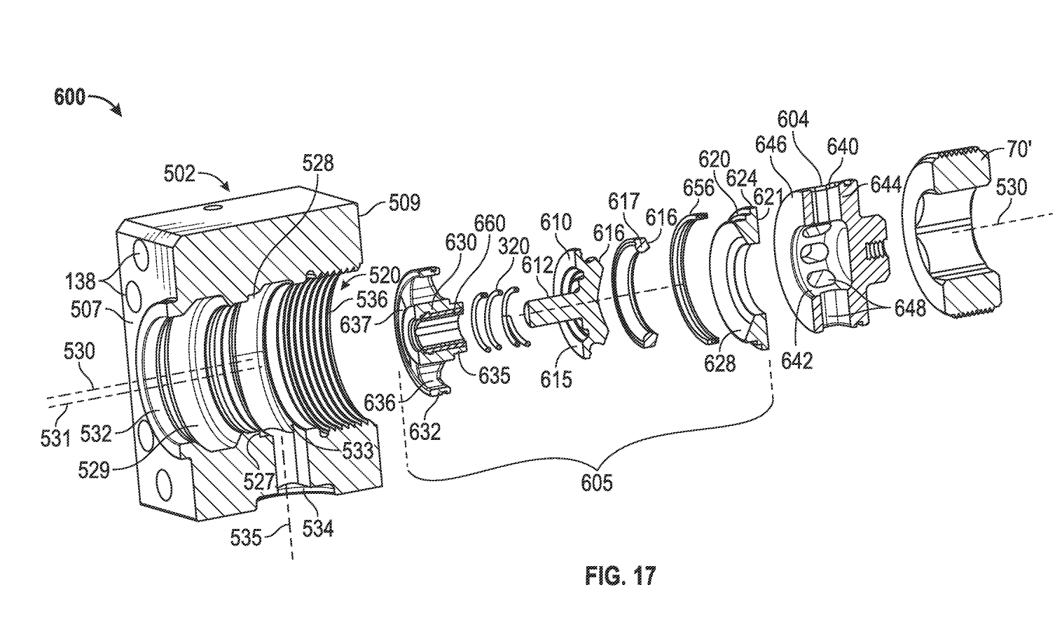

Referring to FIGS. 16 and 17, suction valve module 600 generally includes a valve housing block 502, a longitudinal suction valve axis 530, a valve cage 604, a valve assembly 605, and a cylindrical retainer 70′. Valve cage 604, valve assembly 605, and retainer 70′ are coaxially aligned along valve axis 530 and disposed within through-bore 520 of housing block 502. Valve block 502 is substantially the same as block 102′ previously described. Namely, valve block 502 includes valve axis 530, suction inlet 534 having an inlet axis 535, and outermost and inner surfaces 507, 509. Valve block 502 also includes a through-bore 520 coaxially aligned with valve axis 530 and having generally central portion of increased diameter 528, a second portion of increased diameter 529 proximal to innermost surface 509, and portion of reduced diameter 532. In addition, through-bore 520 includes an annular shoulder 527 facing increased diameter portion 528 and disposed between portions 528, 529. Although central portion 528 has been described as having an increased diameter since it has relatively greater radial dimensions, central portion 528 is actually elliptical, having as its first axis the axis 530 and having as its second axis an axis 531 that is parallel to axis 530 and more proximal to suction inlet 534. Approximately half of the increased diameter portion 528 includes a wall 533 adjacent inlet 534. Wall 533 tapers smaller as it extends away from inlet 534. In various other embodiments, portion 528 may be formed in other shapes. Increased diameter portion 528 provides advantageous flow distribution around valve cage 604.

As shown in FIGS. 16 and 17, suction valve axis 530 is skewed (i.e., is non-parallel) relative to inlet axis 535 and discharge valve axis 57. In particular, valve axis 530 is perpendicular to both inlet axis 535 and discharge valve axis 57. Thus, suction inlet 534 extends generally perpendicular to valve axis 530 and intersects the through-bore 520 in the increased diameter portion 528. A suction pipe 504 is coupled to inlet 534 and functions as a manifold to interconnect multiple modules 600 operating within multiple pumps 510 (not shown)

Cylindrical valve cage 604 and valve assembly 605 of suction valve module 600 are disposed within through-bore 520 for selectively conducting or inhibiting fluid flow therethrough. Valve cage 604 includes cylindrical sidewall 640 surrounding an interior chamber 642, a closed end 644, an open end 646, and a plurality of circumferentially-spaced apertures 648 extending radially through sidewall 640 to interior chamber 642 and allowing fluid communication therethrough. Chamber 642 extends axially from closed end 644 through open end 646. In the embodiment of FIG. 17, chamber 642 has a generally constant diameter and apertures 648 are elongate slots oriented parallel to axis 530.

Referring still to FIGS. 16 and 17, valve assembly 605 includes a movable poppet element or poppet valve member 610 having a stem 612 coaxially aligned with axis 530, an annular valve seat 620, a valve guide 630 through which stem 612 extends, and a biasing member or spring 320 disposed between poppet valve member 610 and valve guide 630. Valve seat 620 includes a first end 621, a radially-extending flange 624 at first end 621, and an annular beveled seating surface 628 opposite first end 621. Poppet valve member 610 includes a generally disc-shaped body 615 having an annular frustoconical surface 616 provided with an annular seal gasket 617. Surface 616 is designed for sealingly engaging the beveled seating surface 628 of valve seat 620.

Valve guide 630 includes an annular base 632 and a concentric guide sleeve 635 coupled to base 632 with a plurality of circumferentially-spaced radial supports 636. A plurality of flow passages 637 are disposed between radial supports 636. Guide sleeve 635 is coaxially aligned with valve axis 530. A friction-reducing bushing 660 is retained within guide sleeve 635. Stem 612 of poppet valve member 610 is slidingly disposed within bushing 660.

Referring again to FIGS. 15 and 16, suction valve module 600 is coupled to the discharge block 514 by bolts or similar threaded fasteners 169 received in through-bores 138 of valve housing block 502 and threaded into counter bores in block 514. As best shown in FIG. 16, through-bore 559 in block 514 includes an enlarged counter bore 562 configured to receive reduced diameter portion 532 of block 502. Valve cage 604 is installed adjacent valve assembly 608 and both are retained within housing block 502 by the cylindrical retainer 70′, which threadingly engages segment a 536 of through-bore 520. In this arrangement, valve guide 630 is positioned within reduced diameter portion 532 and extends further to contact the radially-extending surface of counter bore 562. Flange 624 of valve seat 620 is held against surface 527 of through-bore 520. An annular sealing member 656 is positioned around valve seat 620 between flange 624 and a portion 529 of through-bore 520. A resilient annular member 657A is disposed in a circumferential groove in the outer circumference of annular base 632. In various embodiments, resilient annular member 657A is an O-ring; although, member 657A functions as a positioning feature rather than a seal, helping to ensure valve guide 630 is concentric to valve axis 530. An annular sealing member 657B is disposed in a circumferential groove in sidewall 640 of cage 604. Slots 648 of cage 604 align with increased diameter portion 528 of through-bore 520 and generally align with suction inlet 534. As assembled, spring 320 is compressed and consequently generates a force biasing poppet valve member 610 axially away from base 632 of valve guide 630 and into contact with valve seat 620.

Referring to FIGS. 15 and 16, the operation of suction valve module 600 is substantially the same as module 100 previously described. In general, fluid is drawn through fluid inlet 534, bore 520, and cage 604 of suction valve module 600, passing into bore 559 of block 514. Fluid entering the suction valve module 600 undergoes a change in direction, i.e., essentially makes a right-angle turn, before it impinges on valve seat 620 or the sealing surface 416 of poppet 410. Thus, module 600 avoids developing the high stress and high wear location described with reference to FIG. 8.

When suction pressure (i.e., vacuum) within pump 50 causes spring 320 to compress, fluid flows through the center of annular valve seat 620 and around annular sealing surface 616 of poppet valve member 610. Fluid travels radially into and axially through increased diameter portion 529 of through-bore 520. The fluid then exits through flow passages 637. The travel distance of poppet member 610 is limited by guide sleeve 635. Thus, disc-shaped body 615 is inhibited from contacting the base 632, thereby maintaining an open flow path between increased diameter portion 529 and exit passages 637 for fluid to leave suction module 600 and enter bore 559. In some embodiments, the outer diameter associated with exit passages 637 is greater than the outermost diameter of poppet member 610, which also facilitates the open flow path for fluid to exit suction module 600.

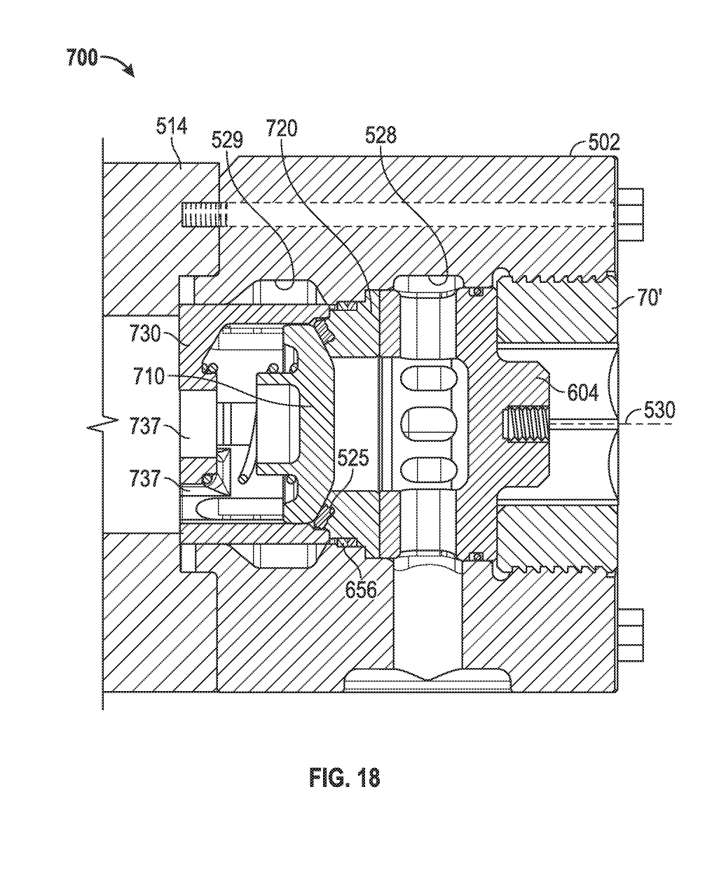

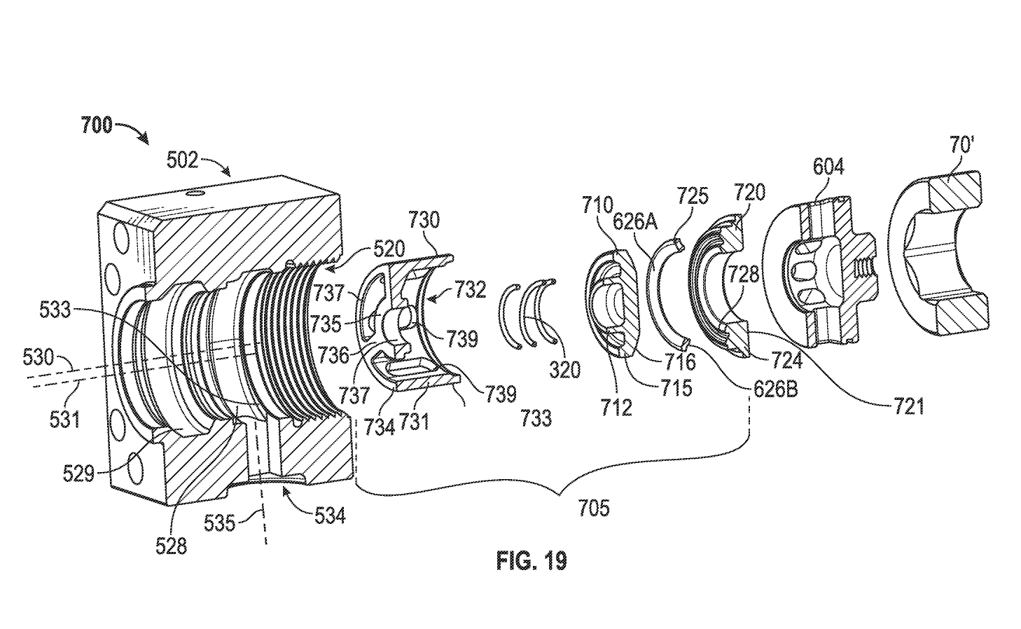

Referring now to FIGS. 18 and 19, another embodiment of a suction valve module 700 in accordance with the principles described herein is shown. Suction valve module 700 includes a valve housing block 502 having a through-bore 520 with a longitudinal suction valve axis 530, a cylindrical valve cage 604, and a cylindrical retainer 70′, each as previously described. In addition, valve module 700 includes a valve assembly 705. Valve cage 604, valve assembly 705, and retainer 70′ are coaxially aligned along valve axis 530 and disposed within through-bore 520 of housing block 502. Valve block 502 includes suction inlet 534 having an inlet axis 535. As shown in FIGS. 18 and 19, suction valve axis 530 is skewed (is non-parallel) relative to inlet axis 535. In particular, valve axis 530 is generally perpendicular to inlet axis 535. Valve cage 604 and valve assembly 705 of suction valve module 700 are designed to selectively conduct or inhibit fluid flow within through-bore 520.

Referring still to FIGS. 18 and 19, valve assembly 705 includes a movable poppet element or poppet valve member 710 having a disc-shaped body 715, an annular valve seat 720, an annular seating gasket 625, an outlet cage 730, and a biasing member or spring 320 disposed between poppet valve member 710 and outlet cage 730. Poppet valve member 710 includes an annular, frustoconical surface 716 disposed around disc-shaped body 715 and a tubular portion 712 extending axially from body 715. Valve seat 720 includes a first end 721, a radially-extending flange 724 at first end 421, and an annular frustoconical seating surface 728 opposite first end 421. Annular seating gasket 625 includes first and second frustoconical seating surfaces 626A, 626B, with first surface 626A configured to mate and sealingly engage seating surface 728 on valve seat 720. Facing poppet valve member 710 and being axially supported by valve seat 720, second seating surface 626B is configured to mate and sealingly engage frustoconical surface 716.

Outlet cage 730 generally includes cylindrical sidewall 731 surrounding an interior chamber 732, an open end 733, a partially closed end or base 734, and a plurality of circumferentially-spaced apertures 739 extending through sidewall 731 to interior chamber 732 and allowing fluid communication therethrough. Chamber 732 extends axially from closed end 734 through open end 733. In the embodiment of FIG. 19, chamber 732 has a generally constant diameter and relief apertures 739 are elongate slots oriented parallel to axis 530. Base 734 includes a central sleeve 735 and a plurality of radial supports 736 extending inward from sidewall 731 to sleeve 735. Flow passages 737 are formed between radial supports 736.

Suction valve module 700 couples to a pump, such as pump 510, in substantially the same manner as previously described for module 600. As assembled, poppet valve member is slidingly received within chamber 732 of outlet cage 730. Open end 733 of cage engages a lip around valve seat 720 adjacent the surface 728. Within the cage 730, spring 320 is disposed around sleeve 735, being held by base 734 at one end and being held against poppet body 715 at the other end. In this assembled state, spring 320 is compressed and consequently biases poppet valve member 710 axially away from base 734 of outlet cage 730 and into sealing contact with valve seat 720. The flow pattern from inlet 534 to through-bore 520 through the suction valve module 700 of FIG. 18 is generally the same as for various other embodiments that were described previously, this arrangement, like those, also avoiding the high stress and high wear location described with reference to FIG. 8.

Various other embodiments formed in accordance with principles disclosed herein exclude a cage in the suction valve module. For example, using a housing block having a through-bore with second portion of increased diameter 129, like block 102′, the poppet valve member or the valve seat directly couple the through-bore of the housing block. The poppet member or valve seat may be held against a radially-extending surface or ledge formed in the through-bore instead of being held in a cage. In these embodiments as with the others disclosed herein, the suction valve axis is skewed (is non-parallel) relative to the inlet axis of the suction valve module, and entering fluid would undergo a change in direction, e.g. make a right-angle turn, before impinging on the valve seat or the sealing surface of the poppet.

In various embodiments, one or more suction valve modules 100, 200, 300, 400 are coupled to a pump 510 instead of a pump 50. In various other embodiments, one or more suction valve modules 600, 700 are coupled to a pump 50 instead of a pump 510. In some embodiments, a combination of various suction valve modules 100, 200, 300, 400, 600, 700 are coupled to a single pump 50, 510. Although the suction modules 100, 200, 300, 400, 600, 700 have been shown on piston and plunger pumps, other embodiments in keeping with the technology disclosed herein apply any of these suction modules to diaphragm pumps or other pumps that utilize a suction module.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A device for pumping a fluid, the device comprising:
a suction valve module;
a discharge valve module;
a fluid flow passage extending between the suction valve module and the discharge valve module;
wherein the suction valve module includes:
a valve housing block having a through-bore and a fluid inlet that intersects the through-bore;
a suction valve assembly disposed within the through-bore; the suction valve assembly including a moveable poppet element configured to reciprocate along a suction valve axis; and
a valve cage disposed within the through-bore;
wherein the valve cage has a closed end, an open end, a cylindrical side wall extending from the open end to the closed end, and an interior chamber disposed within the side wall;
wherein the sidewall includes a plurality of circumferentially-spaced apertures extending radially therethrough, the apertures being configured to allow fluid to flow from the fluid inlet into the interior chamber.

2. The device of claim 1, wherein the suction valve axis is oriented perpendicular to a central axis of the fluid inlet.

3. The device of claim 1, wherein the discharge valve module comprises a valve assembly having a movable poppet element configured to reciprocate along a discharge valve axis that is skewed relative to the suction valve axis.

4. The device of claim 3, wherein the suction valve axis is perpendicular to the axis of the fluid inlet.

5. The device of claim 1, further comprising;
a piston disposed in a cylinder and adapted to reciprocate in the cylinder along a central axis of the cylinder, wherein the piston is configured to draw fluid into the suction valve module through the fluid inlet upon the piston moving in a first direction along the central axis of the cylinder;
wherein the suction valve axis is oriented parallel to the central axis of the cylinder.

6. (canceled)

7. The device of claim 6, wherein the apertures comprise elongate slots oriented parallel to the suction valve axis.

8. The device of 6, wherein the valve cage further comprises an annular extension extending from the closed end into the chamber, and
wherein the movable poppet element includes a stem in sliding engagement with the annular extension.

9. The device of claim 8, wherein the stem comprises a hollow receiving end disposed about the annular extension or the stem includes an end slidingly received within the annular extension.

10. The device of claim 9, further comprising a biasing member configured to bias the moveable poppet element towards the closed end.

11. The device of claim 6, further comprising an annular valve seat disposed in the valve housing block between the moveable poppet element and the valve cage, and wherein the moveable poppet element is configured to reciprocate into and out of engagement with the valve seat.

12. The device of claim 6, further comprising:
an annular valve seat disposed in the housing block adjacent the valve cage;
a biasing member compressed between the moveable poppet element and the valve housing block, wherein the biasing member is configured to bias an annular sealing surface of the moveable poppet element into engagement with the valve seat.

13. The device of claim 1, wherein the valve housing block has a through-bore and a valve cage disposed within the through-bore, wherein the fluid inlet intersects the through-bore;
wherein the valve cage has a first end, a second end, and a cylindrical side wall extending from the first end to the second end, and an interior chamber disposed within the side wall;
wherein the sidewall includes a first plurality of circumferentially-spaced apertures extending radially therethrough and a second plurality of circumferentially-spaced apertures extending radially therethrough, wherein the first plurality of apertures are positioned between the first end and the second plurality of apertures;
wherein the first plurality of apertures are configured to allow fluid to flow from the fluid inlet into the interior chamber.

14. The device of claim 13, further comprising:
an annular valve seat disposed in the valve cage between the first plurality of apertures and the second plurality of apertures;
wherein the moveable poppet element is biased into engagement with the valve seat.

15. The device of claim 1, wherein the valve housing block has a through-bore and a valve cage disposed within the through-bore, wherein the fluid inlet intersects the through-bore;
wherein the valve cage has a closed end, an open end, and a cylindrical side wall extending from the first end to the second end, and an interior chamber disposed within the side wall;
wherein the sidewall includes a plurality of circumferentially-spaced apertures extending radially therethrough, wherein the apertures are configured to allow fluid to flow from the fluid inlet into the interior chamber;
wherein the open end includes an annular valve seat;
wherein the moveable poppet element is biased into engagement with the valve seat.

16. A suction valve module for a pump, comprising:
a housing including flow bore extending therethrough along a valve axis, a first end, and a second end opposite the first end, wherein the flow bore includes a reduced diameter portion at the second end of the housing forming a fluid passageway for fluid to exit the housing;
a fluid inlet extending through the housing an inlet axis to the flow bore, wherein the inlet axis is skewed relative to the valve axis;
a valve cage coaxially disposed in the flow bore, wherein the valve cage includes a first end, a second end, a cylindrical side wall disposed between the first end and the second end of the valve cage, an interior chamber disposed within the side wall between the first end and the second end of the valve cage, and a plurality of apertures extending radially through the side wall to the interior chamber;
a valve seat having an annular seating surface disposed in the flow bore; and
a poppet valve member configured to reciprocate axially relative to the valve axis within the flow bore;
a biasing member configured to bias an annular sealing surface of the poppet valve member into engagement with the annular sealing surface of the valve seat.

17. The suction valve module of claim 16, wherein the valve axis is oriented perpendicular to the inlet axis.

18. The suction valve module of claim 16, wherein the first end of the valve cage comprises the valve seat.

19. The suction valve module of claim 16, wherein the valve seat is positioned adjacent the valve cage or disposed within the valve cage.

20. A reciprocating pump, comprising:
a power end configured to reciprocate a piston within a cylinder;
a fluid end coupled to the power end and configured to draw fluid into the pump when the piston moves in a first direction and to discharge fluid from the pump when the piston moves in a second direction opposite the first direction, the fluid end further comprising:
a suction valve module;
a discharge module;
a fluid flow passage extending between the suction valve module and the discharge valve module and providing fluid communication therebetween;
wherein the suction valve module comprises:
a fluid inlet for conveying fluid into the suction valve module in a first direction;
a suction valve assembly disposed in the suction valve module, the suction valve assembly including a movable poppet element configured to reciprocate within the suction valve module along a valve axis that is skewed relative to the first direction;
a housing block having a through-bore; and
a valve cage disposed within the through-bore, the valve cage having a cylindrical side wall surrounding an interior chamber, the interior chamber being disposed between the valve inlet and the poppet element;
wherein the sidewall includes a plurality of apertures disposed about the suction valve axis for allowing fluid to flow from the fluid inlet into the interior chamber before passing the poppet element.

21. (canceled)

22. The reciprocating pump of claim 20 wherein the valve axis is oriented perpendicular to the first direction.

23. The reciprocating pump of claim 20 wherein the valve axis is oriented parallel to the first and second directions of movement of the piston.

24. The device of claim 1, wherein the suction valve axis is skewed relative to a central axis of the fluid inlet.

25. The device of claim 1, wherein the interior chamber of the valve cage is disposed between the valve inlet and the poppet element, and the valve cage is configured to allow fluid to flow from the fluid inlet into the interior chamber before passing the poppet element.
